(19) United States
(12) Patent Application Publication
(10) Pub. No.: US 2006/0166043 A1
(43) Pub. Date: Jul. 27, 2006

(54) External battery pack

(76) Inventors: Jeong-Ho Eom, Gyeonggi-do (KR); Kyeng-Jun Lee, Seoul (KR)

Correspondence Address: GREENBLUM & BERNSTEIN, P.L.C., 1950 ROLAND CLARKE PLACE, RESTON, VA, 20191, US

(21) Appl. No.: 10/531,988

(22) PCT Filed: Apr. 1, 2003
(86) PCT No.: PCT/KR03/00652

§ 371 Date: Apr. 20, 2005

(30) Foreign Application Priority Data
Oct. 26, 2002 (KR) 1020020065693

(51) Int. Cl. H01M 2/10; H01M 10/46; H02J 7/00

(52) U.S. Cl. 429/7; 429/98; 320/110

(57) ABSTRACT

An external battery pack is provided. The external battery pack includes a secondary battery, an internal circuit, a housing having the secondary battery and the internal circuit, and an inserting portion. The inserting portion is formed in the housing, and the inserting portion is capable of inserting and fixing a portable electronic device. In addition, the external battery pack preferably further includes a pen type fixing unit having a holding part and the inserting portion preferably includes a supporting portion and an inserting rib.

### TECHNICAL FIELD

The present invention relates generally to an external battery pack and, more particularly, an external battery pack having a pen type fixing unit in a housing for carrying comfortably and potably and a charging/outputting circuit unit having a controlling function of constant voltage and constant current, thereby supplying driving power source with a portable electronic device and concurrently charging an internal battery pack of the portable electronic device.

### BACKGROUND ART

Generally, a rechargeable battery such as a Lithium-ion (Li⁺) battery, a Nickel—Cadmium (Ni—Cd) battery, and a Nickel-Metal hybrid (Ni-MH) battery, which is can be used for being semi-permanent, is called a secondary battery.

The demand of the secondary battery is greatly increased as increasing a portable electronic device usage such as a portable computer, a camcorder, a cellular phone, and etc.

However, as the portable electronic device has high performance and multiple functions, driving power source needed to the portable electronic device can be insufficient. Further, the capacity of an internally installed battery may be limited to increase because of being a smaller and slimmed portable electronic device. In addition, supplementary power source (or an external battery pack) is needed for supplying sufficient driving power source with the electronic device.

A conventional external battery pack generally uses an output circuit having a function of constant voltage control and supplies power source with the portable electronic device through an input terminal of an alternating current/direct current adapter (AC/DC adapter) therein. However, in case that the device dose not have an AC/DC adapter or the device has an input terminal directly connected to an internally installed battery pack for supplying power source, it is impossible to use the conventional external battery pack.

In addition, as the portable electronic device is generally used for outing, an external battery pack concurrently used with the portable electronic device should be portably comfortable. Instead, the conventional external battery pack is not comfortable for portably carrying.

Further, as the conventional external battery pack has a charging circuit unit and an output circuit unit as separated circuit unit, it is not easy to make a smaller external battery pack and it is not economical.

It is therefore an object of the present invention to provide an external battery pack including a pen type fixing unit in a housing for fixing at clothing or a belt and an inserting unit for inserting and fixing a portable electronic device, and having a hands-free function, thereby providing a portable and comfortable external battery pack.

It is another object of the present invention to provide an external battery pack including a charging/outputting unit and a circuit converting connector for selecting an internal circuit according to a using condition.

### DISCLOSURE OF THE INVENTION

To achieve the objects of the present invention, an external battery pack preferably includes a secondary battery, an internal circuit, and a housing having the secondary battery and the internal circuit, an inserting portion is formed in the housing, and the inserting portion is capable of inserting and fixing a portable electronic device.

In addition, the external battery pack preferably further includes a pen type fixing unit having a holding part, the pen type fixing unit is formed at a rear side of the housing for being held on clothing or a belt. The inserting portion preferably includes a supporting portion on a front bottom side of the housing and an inserting rib on both lateral sides of the housing.

According to a preferred embodiment of the present, the inserting portion preferably further includes a fixing hook capable of moving in a vertical direction. The inserting portion further includes a detaching protection portion capable of moving up and down, the detaching protection portion is connected to an elastic material installed in the housing.

Furthermore, a portable electronic device or a battery therein can include a few circuit parts selected from the internal circuit parts included in the external battery pack according to an embodiment of the present invention. Therefore, the internal circuit included in the external battery pack can be made various types excepting a few circuits included in the portable electronic device or the battery therein.

### BRIEF DESCRIPTION OF THE DRAWINGS

The above and other objects and advantages of the present invention will become more apparent by describing in detail preferred embodiments thereof with reference to the accompanying drawings in which:

FIG. 1 is a block diagram of an internal circuit in an external battery pack according to an embodiment of the present invention;

FIG. 2 is a block diagram of an internal circuit connection during charging a secondary battery in an external battery pack according to an embodiment of the present invention;

FIG. 3 is an block diagram of an internal circuit connection during outputting power source from an external battery pack to a portable electronic device according to an embodiment of the present invention;

FIG. 4 is a diagram showing a charging method of a Lithium-ion secondary battery;

FIG. 5 is a schematic diagram of a housing of an external battery pack according to an embodiment of the present invention;

FIG. 6 is a schematic diagram of a housing of an external battery pack according to another embodiment of the present invention; and

FIG. 7 is a schematic diagram of a housing of an external battery pack according to another embodiment of the present invention.

### DESCRIPTION OF THE NUMERALS OF DRAWINGS

10 secondary battery
20 charging connector
30 charging/outputting circuit unit
31 charging circuit unit
32 output circuit unit
40 protection circuit unit
50 DC/DC voltage converting circuit unit
60 power source output connector
70 battery remaining display circuit unit
80 battery remaining display unit
90 pen type fixing unit
100 supporting portion
110 inserting rib
120 inserting unit
130 hands-free selection unit
140 speaker
150 microphone
160 circuit converting male connector
170 circuit converting male connector
180 detaching protection jaw
190 connection bar
200 detection protection unit
210 groove
220 spring
225 fixing hook
230 pin
d1 first diode
d2 second diode

### BEST MODE FOR CARRYING OUT THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. Moreover, each embodiment described and illustrated herein includes its complementary conductive type embodiment as well.

An external battery pack according to an embodiment of the present invention will be described by using the attached drawings.

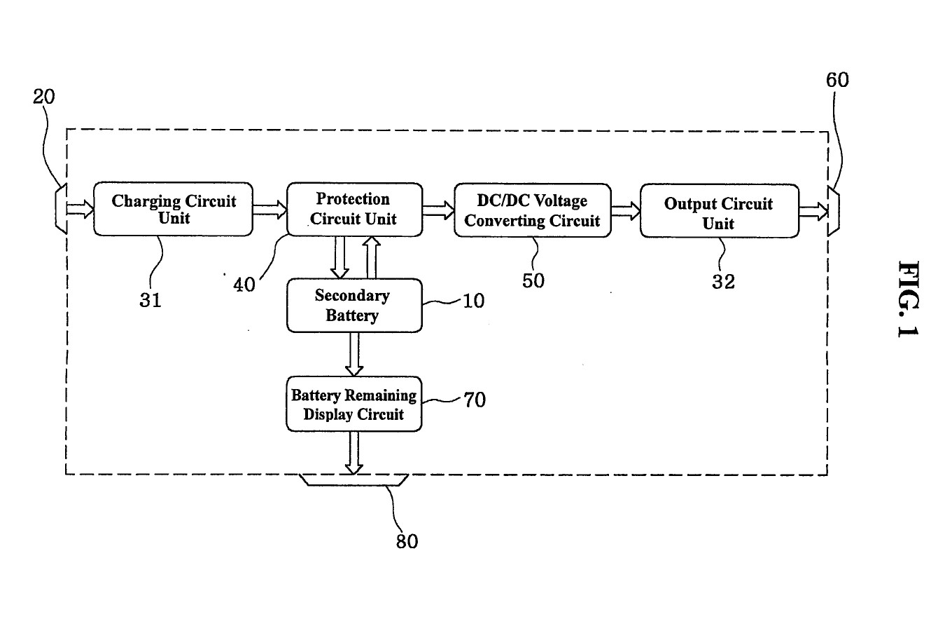

FIG. 1 is a block diagram of an internal circuit in the external battery pack according to an embodiment of the present invention. FIG. 1 shows an internal circuit according to an embodiment of the present invention, but a few circuits of the internal circuits cannot be included according to embodiments.

The process of charging and discharging of the external battery pack according to an embodiment of the present invention is described by using FIG. 1.

Referring to FIG. 1, the external battery pack includes a secondary battery 10 and a charging connector 20 connected to an external power source by an extension cable (not shown) for supplying power source.

The external battery pack further includes a charging circuit unit 31 connected to the charging connector 20. The charging circuit unit 31 converts the supplied power source into a given level of current and voltage for the secondary battery 10 and supplies the converted power source with a protection circuit unit 40.

When the secondary battery 10 is over-charged by supplying exceeded limiting voltage, an organic electrolyte in the secondary battery 10 is decomposed by a decomposition reaction. In contrary, the secondary battery 10 is over-discharged, internal resistance can be increased, thereby deteriorating performance and lowering safety of the secondary battery 10. The protection circuit unit 40 detects the over-charging and over-discharging for the secondary battery 10, disconnects the external circuit, and protects the secondary battery 10 by protecting the over-charging and over-discharging.

The power source having a given level of current and voltage converted from the charging circuit unit 31 and the protection circuit unit 40 is charged into the secondary battery 10.

A DC/DC voltage converting circuit unit 50 converts the charged power source in the secondary battery 10 into another power source suitable for a portable electronic device (not shown).

The charged power source in the secondary battery 10 is supplied to an output circuit unit 32 via the DC/DC voltage converting circuit unit 50.

The output circuit unit 32 performs a constant voltage control and a constant current control to keep the inputted voltage and current from the DC/DC voltage converting circuit unit 50 being constant. Thus, the external battery pack can supply a driving power source with the portable electronic device and concurrently charge an internal battery pack (not shown) included in the portable electronic device.

According to an embodiment of the present invention, the external battery pack further includes a power source output connector 60. The power source output connector 60 is electrically connected to a power source input terminal (not shown) or a battery charging connecting terminal (not shown) of the portable electronic device to supply the power source which is controlled to the constant voltage and the constant current.

According to an embodiment of the present invention, the external battery pack further includes a battery remaining display circuit unit 70 and a battery remaining display 80. The battery remaining display circuit unit 70 detects battery remaining status with given steps and controls to display the battery remaining status in the battery remaining display 80. The battery remaining display 80 can include a color or a mono light emitting diode (LED) for differently displaying light emitting colors according to charging status. Further, the battery remaining display 80 can include a plurality of LEDs for displaying charging status according to a number of the LEDs being “ON”. For example, when the charging status is divided into 4 stages, the number of LEDs is four. When four LEDs are “ON”, it indicates that the battery is substantially fullly charged. When two LEDs are “ON”, it indicates that the battery is substantially half charged.

According to an embodiment of the present invention, the external battery pack can include different elements, various embodiments will be described below.

In case that the external battery pack of the present invention can receive power source and can be connected to a portable electronic device or a battery of the portable electronic device, the external battery pack according to an embodiment of present invention can include some elements among the charging circuit unit 31, the protection circuit unit 40, the DC/DC voltage converting circuit unit 50, and the output circuit unit 32. That is, the external battery according to an embodiment of present invention can be configured not to include all of the above elements, but can be configured to include their combinations.

When the charged power source itself of the secondary battery 10 in the external battery pack is used, the external battery pack according to an embodiment of present invention can only include the charging connector 20, the charging circuit unit 31, and the power source output connector 60.

When constant voltage corresponding to an input of an AC/DC adapter is used, the external battery pack according to an embodiment of present invention can further include the DC/DC voltage converting circuit unit 50. When a portable electronic device uses constant voltage/constant current for charging the secondary battery 10, the external battery pack can further include the output circuit unit 32.

In case that external power source suitable for charging the secondary battery 10 is supplied, the external battery pack can only include the charging connector 20, the DC/DC voltage converting circuit unit 50, and the power source output connector 60. In case that the portable electronic device uses constant voltage/constant current for charging the secondary battery 10, the external battery pack can further include the output circuit unit 32.

For the above embodiments, the external battery pack can further include the protection circuit unit 40 for electrically protecting the secondary battery 10.

In a simple case, it is possible that the external battery pack can only include the secondary battery 10.

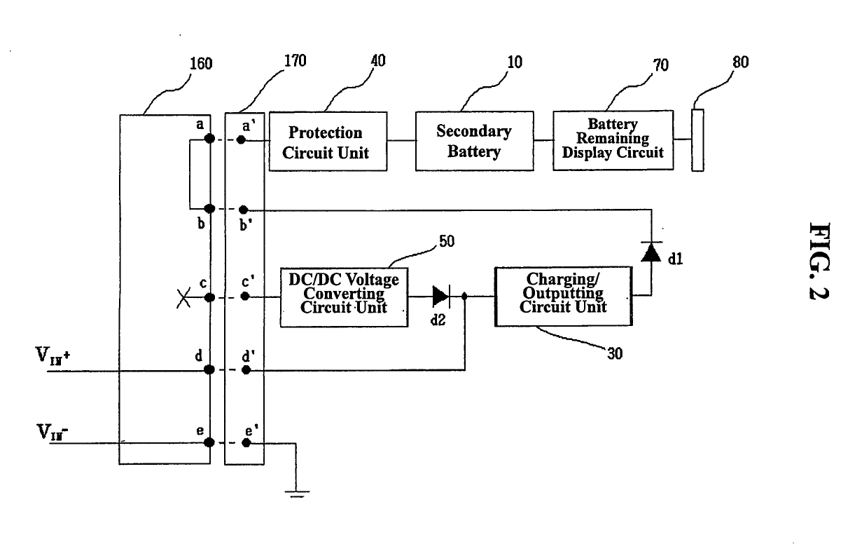

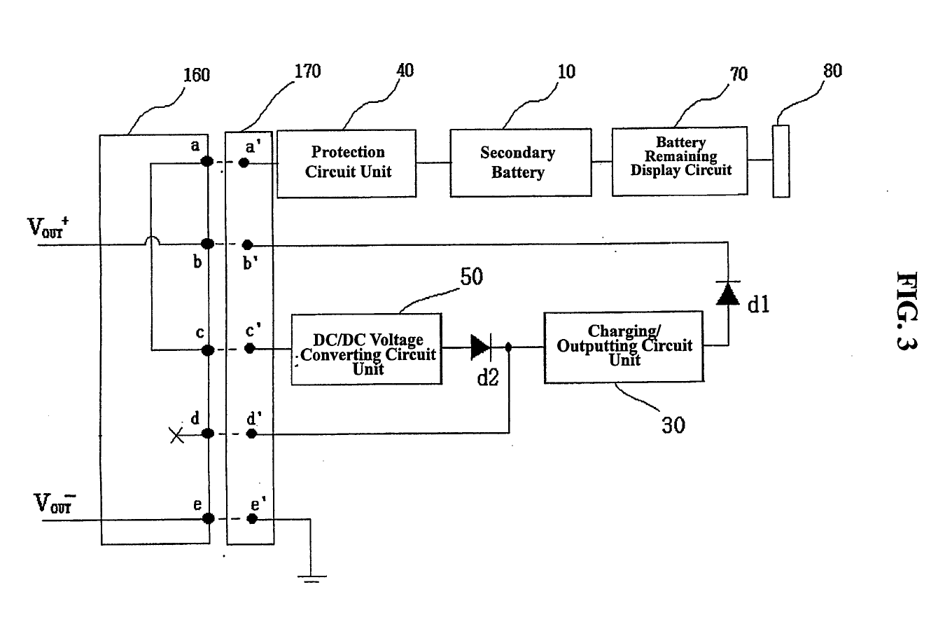

According to another embodiment of the present invention, the charging circuit unit 31 and the output circuit unit 32 can be combined and the external battery pack further includes a circuit changing connector for changing a wiring connection of the internal circuit according to an usage. Detailed embodiments will be described by referring to FIGS. 2 and 3.

FIG. 2 is a block diagram of an internal circuit connection during charging the secondary battery in the external battery pack according to an embodiment of the present invention.

In this embodiment, a circuit changing connector is comprised of a circuit converting male connector 160 and a circuit converting female connector 160.

The circuit converting female connector 170 includes an a′ terminal, a b′ terminal, a c′ terminal, a d′ terminal, and an e′ terminal. The a′ terminal is connected to the protection circuit unit 40. The b′ terminal is connected to a cathode of a first diode d1, wherein an anode of the first diode d1 is connected to a charging/outputting circuit unit 30. The c′ terminal is connected to the DC/DC voltage converting circuit unit 50. The d′ terminal is connected between a second diode d2 and the charging/outputting circuit unit 30. The e′ terminal is connected to ground.

The circuit converting male connector 160 includes a, b, c, d, and e terminals corresponding to the a′, b′, c′, d′, e′ terminals, respectively, of the circuit converting female connector 170.

The d terminal of the circuit converting male connector 160 is connected to a positive terminal V_{IN}⁺ of the charging connector 20, and the e terminal of the circuit converting male connector 160 is connected to a negative terminal V_{IN}⁻ of the charging connector 20 and a negative terminal of the power source output connector 60.

The connection of the a, b, and c terminals of the circuit converting male connector 160 and the positive terminal of the power source output connector 60 can be varied according to the use of the secondary battery 10.

As shown in FIG. 2, when the secondary battery 10 is charged, the a terminal and the b terminal of the circuit converting male connector 160 are connected. Then, charged current inputted from the positive terminal V_{IN}⁺ of the charging connector 20 is sequentially flowed to the d terminal, the d′ terminal, a node f located between the diode D2 and the charging/outputting circuit unit 30, the charging/outputting circuit unit 30, the first diode d1, the b′ terminal, the b terminal, the a terminal, the a′ terminal, the protection circuit unit 40, and the secondary battery 10, thereby charging the secondary battery 10.

FIG. 3 is a block diagram of an internal circuit connection during outputting power source from the external battery pack to the portable electronic device according to an embodiment of the present invention.

When power source is outputted to the portable electronic device, the a terminal and the c terminal of the circuit converting male connector 160 are connected and the b terminal of the circuit male connector 160 is connected to the positive terminal V_{OUT}⁺ of the power source output connector 60. Then, discharging current from the secondary battery 10 is sequentially flowed to the protection circuit unit 40, the a′ terminal, the a terminal, the c terminal, the c′ terminal, the DC/DC voltage converting circuit 50, the second diode d2, the charging/outputting circuit unit 30, the first diode d1, the b′ terminal, the b terminal, the positive terminal V_{OUT}⁺ of the power source output connector 60, thereby supplying the power source with the portable electronic device.

The switching operation as described above for connecting between terminals is performed by a user. Further, the switching operation is automatically performed to connect the a terminal and the b terminal when the power source is inputted from the charging connector 20 as shown in FIG. 2. The switching operation is automatically performed to connect the a terminal and the c terminal, and the b terminal and the positive terminal V_{OUT}⁺ of the power source output connector 60 as shown in FIG. 3 when power source is not supplied. According to an embodiment of the present invention, the connections as described above are examples and connections of the terminals in the circuit converting male connector 160 during charging and outputting can be varied and are not limited. Furthermore, it is possible to make one circuit converting connector (not shown) united from the circuit converting male connector 160 and the circuit converting female connector 170.

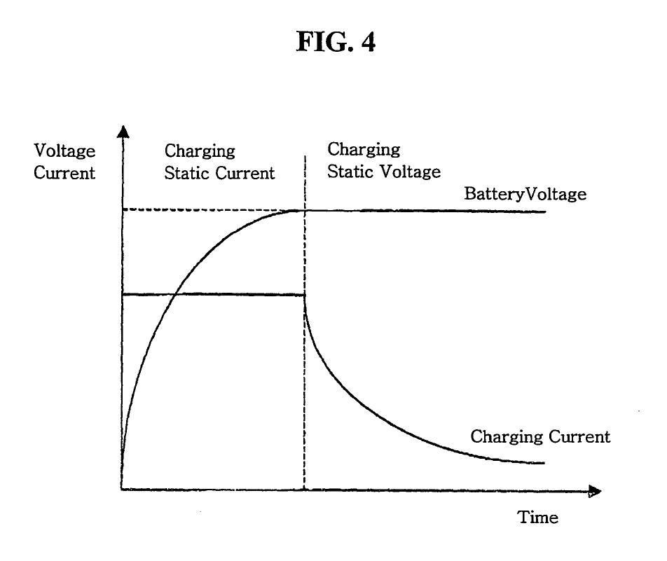

FIG. 4 is a diagram showing a charging method of a Lithium-ion (Li⁺) secondary battery.

As shown in FIG. 4, it is well known in the art that as the Lithium-ion battery is charged during a short period, it is charged by constant current in a first period of charging, and when charging voltage is reached in a given voltage, it is charged by constant voltage, thereby safely fully charging the battery.

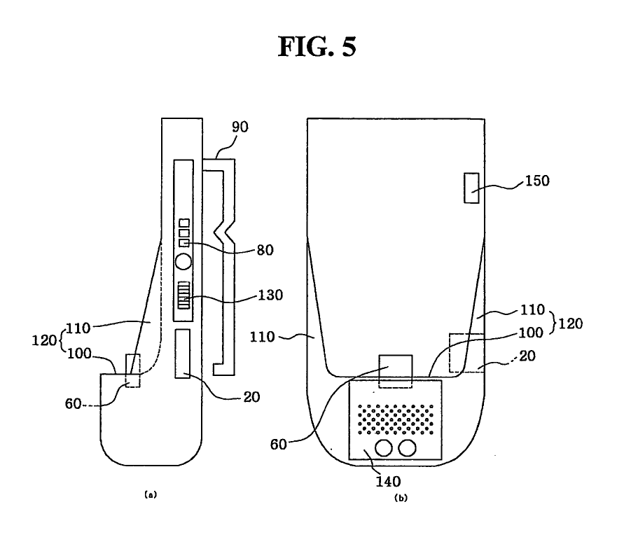

FIG. 5 is a schematic diagram of a housing of the external battery pack according to an embodiment of the present invention. FIG. 5(a) is a lateral diagram of the housing of the external battery pack and FIG. 5(b) is a front diagram of the housing of the external battery pack.

The housing includes the secondary battery and a plurality of circuit units therein, and further includes a pen type fixing unit 90 at one bottom side of the housing for fixing at clothing or a belt.

The pen type fixing unit 90 is made of material having a given elasticity, so as not to be detached from the clothing or the belt. The pen type fixing unit 90 preferably includes a hook at an opposite end the pen type fixing unit 90 connected to the housing.

In FIG. 5, the charging connector 20, the power source output connector 60, and the battery remaining display 80 are formed at a long lateral side of the housing, but it can be formed at a short lateral side near the pen type fixing unit 90 or at a bottom side of the housing. Further, the charging connector 20, the power source output connector 60, the battery remaining display 80, and a hands-free selection unit 130 can be formed at different sides, respectively.

According to an embodiment of the present invention, the hands-free selection unit 130 is formed of a switch. The switch is a slide type switch or a button type switch, but it is not limited to types of the switch.

The charging connector 20 is formed of an attaching-detaching type for suitably exchanging the portable electronic device or the charging connector 20 can include a separated auxiliary connector electrically connected thereto.

A front bottom side of the housing is protruded to the front side, so as to form a supporting portion 100, and a speaker 140 is configured inside of the housing. According to an embodiment of the present invention, a microphone 150 is configured on the top of the housing, but the location of the microphone 150 is not limited. Further, the microphone cannot be included and an externally installed microphone can be used. In case that the externally installed microphone is used, a microphone connecting terminal (not shown) can be configured at a given location of the housing. Further, the microphone connecting terminal for connecting an externally installed microphone and a microphone 150 can be configured together.

The speaker 140 and the microphone 150 can be electrically connected to an audio signal input/output unit of the portable electronic device. According to an embodiment of the present invention, the battery remaining display unit 80, the hands-free selection unit 130, the speaker 140, and the microphone 150 can be selectively configured together or can be partly combined thereof.

Inserting ribs 110 are formed on both lateral sides of the housing for insertedly fixing the portable electronic device. Therefore, an inserting unit 120 including the supporting portion 100 and the inserting ribs 110 can stably fix the portable electronic device not to easily be detached.

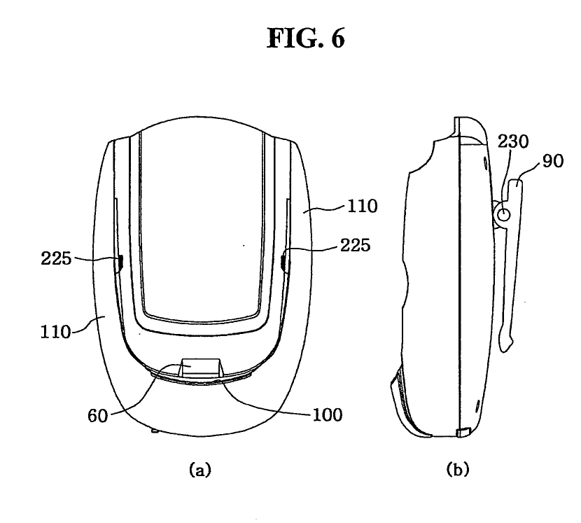

FIG. 6 is a schematic diagram of a housing of the external battery pack according to another embodiment of the present invention.

FIG. 6(a) is a schematic front side diagram of the housing of the external battery pack. FIG. 6(b) is a schematic lateral side diagram of the housing of the external battery pack.

Inserting ribs 110 are formed of both lateral sides of the housing. A plurality of fixing hooks 225 movable in a perpendicular direction are included in inserting ribs 110. According to an embodiment of the present invention, it is preferable to include at least two fixing hooks 225 in the both lateral sides of the rib 110. Each hook 225 is located on the each inserting rib 110. When a portable electronic device is inserted in an inserting portion 120 having the supporting portion 100 and inserting ribs 110, the fixing hooks 225 are also inserted inside by pushing of the portable electronic device. Next, dent parts (not shown) formed at lateral sides of the portable electronic device are fixed in fixing hooks 225 by pushing back from the housing, thereby stably fixing the portable electronic device.

As shown in FIG. 6(b), one part of the pen type fixing unit 90 is fixed by a pin 230 and installed to pull toward the housing, thereby stably fixing at clothing or a belt.

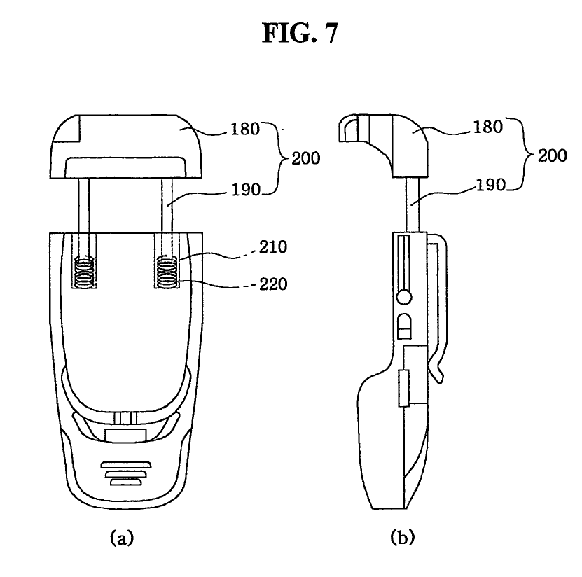

FIG. 7 is a schematic diagram of a housing of the external battery pack according to another embodiment of the present invention.

FIG. 7(a) is a schematic front side diagram of the housing of the external battery pack. FIG. 7(b) is a schematic lateral side diagram of the housing of the external battery pack.

As shown in FIG. 7, a detaching protection unit 200 includes a detaching protection jaw 180 and at least one connection bar 190 connected to the detaching protection jaw 180. At least one groove 210 corresponding to the at least one connection bas 190 is formed in the top area of the housing and the connection bar 190 can be vertically movable in the groove 210. One side of a spring 220 is fixed inside of the groove 210, and the other side of the spring 220 is fixed to the connection bar 190.

A user pulls the detaching protection unit 200 upwardly and inserts and fixes a portable electronic device in the inserting area 120. Next, when the detaching protection unit 200 is released, the top part of the portable electronic device is pulled downwardly, thereby fixing the top part of the portable electronic device. Therefore, the portable electronic device can be protected to be detached upwardly from the housing.

In the drawing, even though the detaching protection unit 200 describes to include two connecting bars 190, it is not limited to include one connecting bar 190 installed at substantially the center of the detaching protection jaw 180 or a plurality of connecting bar 190. Further, according to an embodiment of the present invention, the spring 220 can be replaced another elastic material for connecting the detaching protection unit 200 and the housing.

### INDUSTRIAL APPLICABILITY

The advantages of the external battery pack according to an embodiment of the present invention, which were described above, will now be summarized.

First, as the external battery pack includes an output circuit unit, which outputs a constant voltage and a constant current, the external battery pack can supply driving power source with a portable electronic device and can concurrently charge an internal battery in the portable electronic device.

Second, as the external battery pack includes a battery remaining display circuit unit and a battery remaining display unit, and the battery remaining display unit 80 displays a battery remaining status into various levels according to a battery remaining status, thereby effectively using the external battery pack according to the battery remaining status.

Third, as a charging circuit unit and an output circuit unit can be configured to make one unit, and the charging circuit unit or the output circuit unit can be commonly used, the battery pack can be made of a smaller size or the secondary battery can have larger capacitance.

Fourth, as a pen type fixing unit is used, a portability of the external battery pack can be improved.

Fifth, as an external battery pack includes an inserting unit to insert the portable electronic device, the external battery pack and the portable electronic device can be combined, thereby a portability of the external battery pack can be improved.

While the present invention has been particularly shown described with respect to preferred embodiments thereof, it will be understood by those skilled in the art that various changes in the form and details may be made without departing from the spirit and scope of the invention as defined by the appended claims.

1. An external battery pack comprising:
a secondary battery;
an internal circuit;
a housing having the secondary battery and the internal circuit; and
an inserting portion formed in the housing,
wherein the inserting portion is capable of inserting and fixing an portable electronic device.

2. The external battery pack of claim 1, wherein the external battery pack further comprises a pen type fixing unit having a holding part, the pen type fixing unit is formed at a rear side of the housing for being held on clothing or a belt.

3. The external battery pack of claim 1 or claim 2, wherein the inserting portion comprises a supporting portion on a front bottom side of the housing and an inserting rib on both lateral sides of the housing.

4. The external battery pack of claim 3, wherein the inserting portion further comprises a fixing hook capable of moving in a vertical direction.

5. An external battery pack of claim 3, wherein the inserting portion further comprises a detaching protection portion capable of moving up and down, the detaching protection portion is connected to an elastic material installed in the housing.

6. The external battery pack of claim 2, wherein the internal circuit comprises:
a charging connector for receiving power source;
a charging circuit unit for charging the secondary battery by converting the received power source into constant voltage; and
a power source output connector for outputting the charged voltage in the secondary battery into one of an power source input terminal of the portable electronic device and a charging connection terminal of a battery of the portable electronic device.

7. The external battery pack of claim 6, wherein the internal circuit further comprises a DC/DC voltage converting circuit for converting an inputted voltage from the secondary battery into a given level of DC voltage.

8. The external battery pack of claim 7, wherein the internal circuit further comprises an output circuit unit for outputting the inputted power source from the DC/DC voltage converting circuit, the inputted power source maintains constant voltage and constant current.

9. The external battery pack of claim 2, wherein the internal circuit comprises:
a charging connector for receiving power source supply;
a DC/DC voltage converting circuit for converting an inputted voltage from the secondary battery into a given level of DC voltage; and
a power source output connector for outputting the given level of DC voltage in the DC/DC voltage converting circuit into one of an power source input terminal of the portable electronic device and a charging connection terminal of a battery of the portable electronic device.

10. The external battery pack of claim 9, wherein the internal circuit further comprises an output circuit unit for outputting the inputted power source maintaining constant voltage and constant current from the DC/DC voltage converting circuit, wherein the output circuit unit is configured between the DC/DC voltage converting circuit unit and the power source output connector.

11. The external battery pack of claim 6, wherein the internal circuit further comprises a protecting circuit unit for protecting electrical performance of the secondary battery.

12. The external battery pack of claim 2, wherein the internal circuit comprises:
a charging connector for receiving power source supply;
a charging circuit unit for charging the secondary battery by converting the received power source into constant voltage;
a protecting circuit unit for protecting electrical performance of the secondary battery, the protecting circuit unit being electrically connected between the charging connector and the charging circuit unit;
a DC/DC voltage converting circuit for converting an inputted voltage from the protecting circuit unit into a given level of DC voltage;
an output circuit unit for outputting the inputted power source maintaining constant voltage and constant current from the DC/DC voltage converting circuit.
a power source output connector for outputting the given level of DC voltage in the DC/DC voltage converting circuit into a charging connecting terminal of a battery of the portable electronic device;
a battery remaining display circuit unit for detecting a battery charge remaining status of the secondary battery;
a battery remaining display unit for displaying a battery charge remaining status according to a signal inputted from the battery remaining display circuit unit.

13. The external battery pack of claim 12, wherein the charging circuit unit and the outputting circuit unit are combined to be a charging/outputting circuit unit and the internal circuit further comprises a circuit converting connector for converting a circuit wire connection according to electrical connections between the charging circuit unit and the internal circuit, and between the outputting circuit unit and the internal circuit.

14. The external battery pack of claim 2, wherein the inserting portion comprises a supporting portion on a front bottom side of the housing and an inserting rib on both lateral sides of the housing.

15. The external battery pack of claim 14, wherein the inserting portion further comprises a fixing hook capable of moving in a vertical direction.

16. An external battery pack of claim 14, wherein the inserting portion further comprises a detaching protection portion capable of moving up and down, the detaching protection portion is connected to an elastic material installed in the housing.

17. The external battery pack of claim 7, wherein the internal circuit further comprises a protecting circuit unit for protecting electrical performance of the secondary battery.

18. The external battery pack of claim 8, wherein the internal circuit further comprises a protecting circuit unit for protecting electrical performance of the secondary battery.

19. The external battery pack of claim 9, wherein the internal circuit further comprises a protecting circuit unit for protecting electrical performance of the secondary battery.

20. The external battery pack of claim 10, wherein the internal circuit further comprises a protecting circuit unit for protecting electrical performance of the secondary battery.
